(19) United States
(12) Patent Application Publication
(10) Pub. No.: US 2010/0288837 A1
(43) Pub. Date: Nov. 18, 2010

(54) RFID TAG READING/PROCESSING APPARATUS

(75) Inventors: Takashi TOMIYAMA, Shizuoka (JP); Naohiro MATSUSHITA, Shizuoka (JP); Takafumi FUKUSHIMA, Shizuoka (JP); Tomonari KAKINO, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: TOSHIBA TEC KABUSHIKI KAISHA, Tokyo (JP)

(21) Appl. No.: 12/778,595

(22) Filed: May 12, 2010

(30) Foreign Application Priority Data
May 13, 2009 (JP) 2009-116749

(51) Int. Cl. G06F 17/00; G06K 7/00; G06K 15/00

(52) U.S. Cl. 235/383

(57) ABSTRACT

According to one embodiment, a RFID tag reading/processing apparatus includes a reading device which reads data of the RFID tag, and transmits a radio wave from the antenna to the front to rear side of the container of the moving object, while the opening/closing door is being closed, and a checkout device which checks out for the merchandise based on the RFID tag data read by the reading device.

### CROSS-REFERENCE TO RELATED APPLICATIONS

This application is based upon and claims the benefit of priority from Japanese Patent Application No. 2009-116749, filed May 13, 2009; the entire contents of which are incorporated herein by reference.

### FIELD

Embodiments described herein relate generally to a RFID tag reading/processing apparatus, which permits customers to pay for their purchases while keeping them in a shopping cart (moving object) in a retail store such as a supermarket and a shopping center having a plurality of checkout counters.

### BACKGROUND

Recently, development of techniques using a RFID tag (Radio Frequency Identification tag) has been stepped up to reduce time required for payment in a retail store.

For example, Jpn. Pat. Appln. KOKAI Publication No. 11-120438 discloses a checkout system, in which a RFID tag to transmit merchandise information is attached to every merchandise, and customers can pay for purchased merchandise simply by carrying a shopping cart containing their purchases to a checkout counter.

A large-scale retail store such as a supermarket and a shopping center needs to handle payments of many customers at a time.

Conventionally, a plurality of checkout gates are provided in a checkout area of a store, and customers can check out at the gates. Each gate is provided with an antenna of a RFID tag reader for communicating with a RFID tag attached to merchandise and reading data of a RFID tag.

However, a store space is limited, and gates need to be installed as close to each other as possible. Thus, a radio wave transmitted from an antenna of a RFID tag reader is undesirably received by antennas of adjacent gates, and information about the merchandise in carts passing through adjacent gates is read. This may disturb correct accounting.

To prevent misreading of RFID tags, gates may be covered with radio wave absorbing materials. However, in this case, the size of a gate itself is increased, and undesirable for a store having limited space.

### BRIEF DESCRIPTION OF THE DRAWINGS

FIG. 1 is a perspective view of a checkout gate provided with a RFID tag reading/processing apparatus according to an embodiment of the invention;

FIG. 2 is a magnified perspective view of the RFID tag reading/processing apparatus of FIG. 1;

FIG. 3 is a plan view of the RFID tag reading/processing apparatus of FIG. 2;

FIG. 4 is a view showing a position of an antenna, and a direction of a radio wave transmitted from the antenna, in the RFID tag reading/processing apparatus of FIG. 2;

FIG. 5 is a block diagram of the RFID tag reading/processing apparatus of FIG. 2;

FIG. 6 is a block diagram of a RFID tag reader of the RFID tag reading/processing apparatus of FIG. 2;

FIG. 7 is a flowchart of processing of the RFID tag reading/processing apparatus of FIG. 2;

FIG. 8 shows a guide screen displayed on a touch panel display shown in FIG. 2;

FIG. 9 shows an update screen displayed on the touch panel display of FIG. 2;

FIG. 10 shows a payment confirmation screen displayed on the touch panel display of FIG. 2;

FIG. 11 shows a payment stop screen displayed on the touch panel display of FIG. 2;

FIG. 12 shows a payment completed screen displayed on the touch panel display of FIG. 2;

FIG. 13 is a perspective view of a RFID tag reading/processing apparatus according to another embodiment of the invention; and

FIG. 14 is a perspective view of a RFID tag reading/processing apparatus according to a still another embodiment of the invention.

### DETAILED DESCRIPTION

In general, according to one embodiment, a RFID tag reading/processing apparatus includes a gate for passing a moving object having a container to contain merchandise with a RFID tag, an opening/closing door which is provided with an antenna inside, and opens and closes the gate, a reading device which reads data of the RFID tag, and transmits a radio wave from the antenna to the front to rear side of the container of the moving object, while the opening/closing door is being closed, and a checkout device which checks out for the merchandise based on the RFID tag data read by the reading device.

Hereinafter, a RFID tag reading/processing apparatus according to an embodiment of the invention, applied to a checkout system in a large-scale retail store such as a supermarket, will be explained with reference to the accompanying drawings.

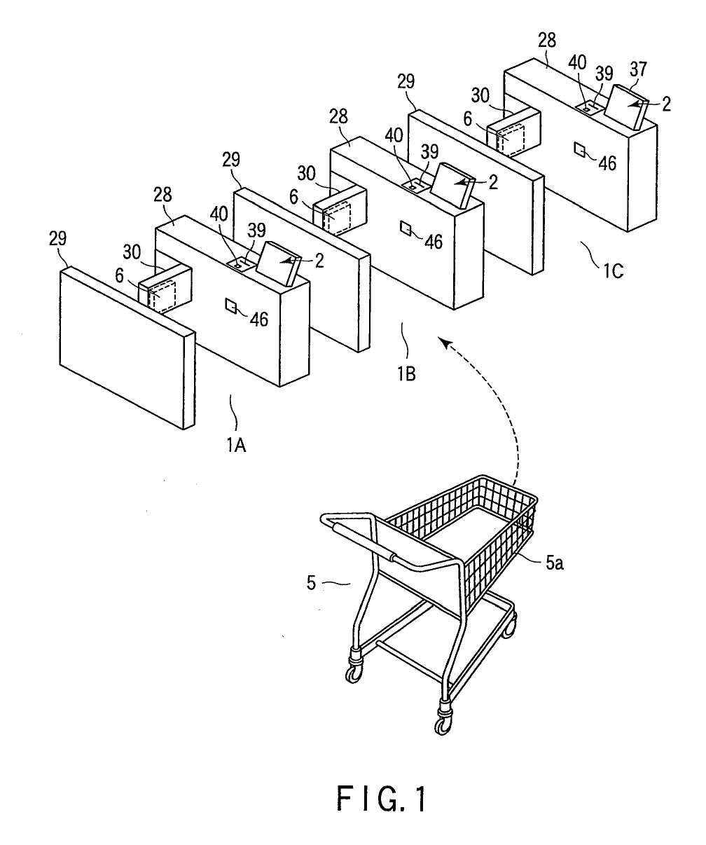

FIG. 1 is a perspective view of a checkout system in the embodiment.

The system comprises a plurality of checkout gates 1A, 1B and 1C (three gates in the drawing), and a plurality of RFID tag reading/processing apparatus 2 provided in each gate.

In this embodiment, a RFID tag is attached to every merchandise sold in a store, and a specific tag ID set for each RFID tag is set as an ID of merchandise to which the RFID tag is attached.

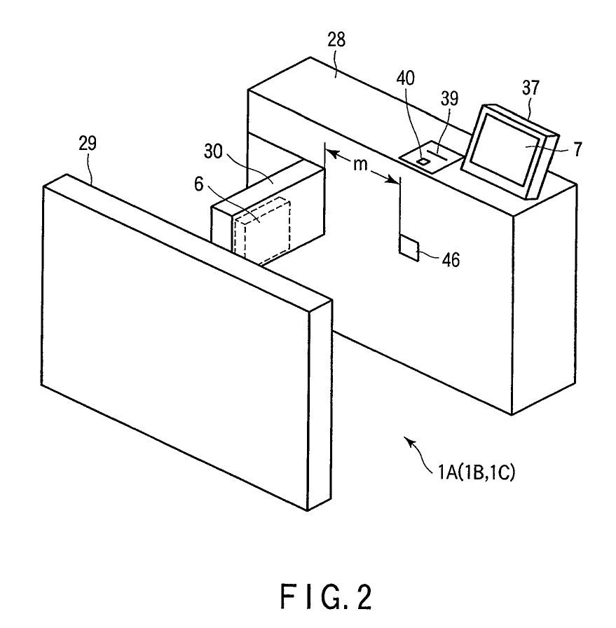

As shown magnified in FIG. 2, each checkout gate 1A, 1B and 1C comprises a gate main unit 28, and an auxiliary board 29, which are placed on opposite sides of a space to pass A customer pushing a shopping cart 5 as a moving object (shown in FIG. 1). The shopping cart 5 includes a basket 5a as a container to contain merchandise with RFID tags.

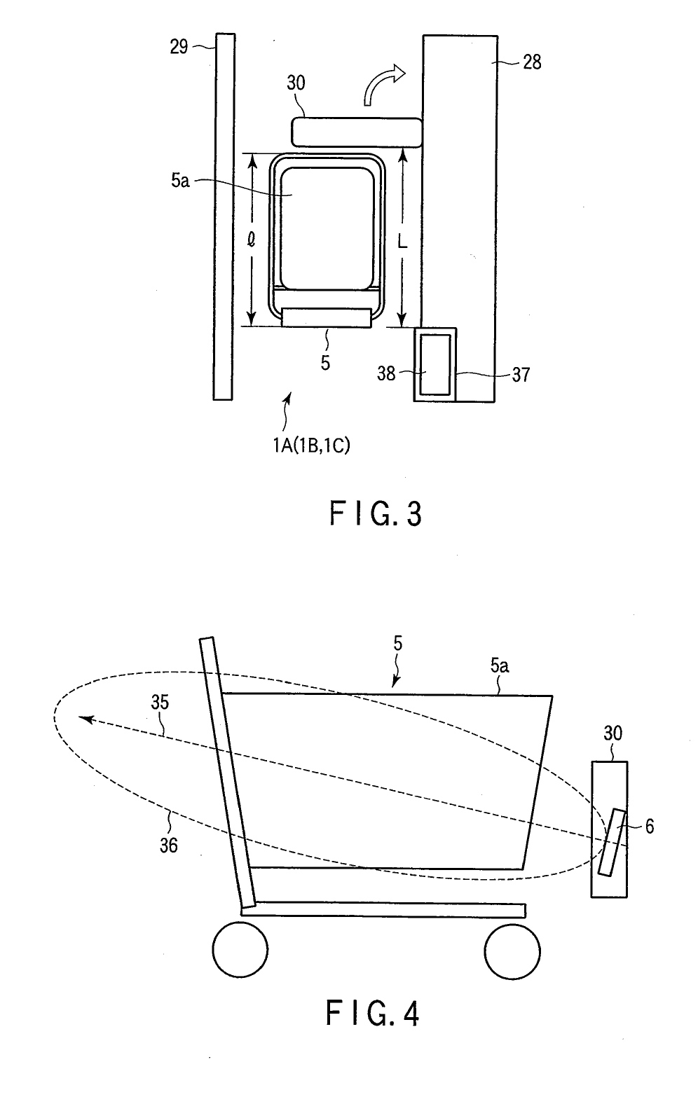

A flap door 30 as an opening/closing door is provided on the side of the gate main unit 28. A RFID tag reading antenna 6 is provided inside the flap door 30. As shown in FIG. 3, while the flap door 30 is being closed, the RFID tag reading antenna 6 is faced to the front side of the basket 5a of the shopping cart 5. As shown in FIG. 4, the RFID tag reading antenna 6 is obliquely positioned, so that a radio wave 36 is transmitted obliquely upward from the lower front side to upper rear side of the basket 5a of the shopping cart 5.

Therefore, the radio wave 36 transmitted from the RFID tag reading antenna 6 is not directed to subsequent shopping carts or shopping carts in adjacent gates, preventing reading of a RFID tag of unconcerned merchandise.

Further, as shown in FIGS. 2 and 3, a checkout processor 37 as a checkout device is provided on the front upper side of the gate main unit 28. As shown in FIG. 3, the distance L from the flap door 30 to the checkout processor 37 is greater than the length along the advancing direction of the shopping cart 5.

Therefore, when the shopping cart 5 is pushed into the gate 1A (1B or 1C) and its front end is faced to the flat door 30, The customer can stand in front of the checkout processor 37. The checkout processor 37 has a touch panel display 7 as an operation display on the front side. The customer standing in front of the checkout processor 37 can touch the touch panel.

On the top of the gate main unit 28, a receipt printer 39 as a receipt issuing device, and a receipt detection sensor 40 located before the printer to optically detect an issued receipt, are provided near the checkout processor 37.

A cart detection sensor 46, as a moving object detection sensor for detecting a shopping cart pushed into the gate, is provided on the side of the gate main unit 28. The cart detection sensor 46 uses a reflective photosensor.

The distance m from the flap door 30 to the cart detection sensor 46 is set equal to the half of the length along the advancing direction of the shopping cart 5, so as to certainly detect a shopping cart.

The antenna 6 makes wireless communication with a RFID tag attached to the merchandise contained in the basket 5a of the shopping car 5 passing between the gate main unit 28 and auxiliary board 29, or those carried by The customer pushing the cart 5, and receives a tag ID, or a merchandise ID from the RFID tag.

The touch panel display 7 displays a payment guide screen, a registered merchandise screen, a payment screen, and a payment stop screen, described later, and functions as an input device of the buttons displayed on these screens.

The checkout processor 37 handles payment for merchandise in cash or by a credit card. For payment in cash, the processor calculates change from the price of merchandise and the amount of money input from a cash insertion slot, outputs the change from a change outlet, and prints and issues a receipt. For payment by a credit card, the processor asks a host computer to authenticate the payment by a credit card read through a card reader, and prints and issues a credit slip when the credit card is authenticated.

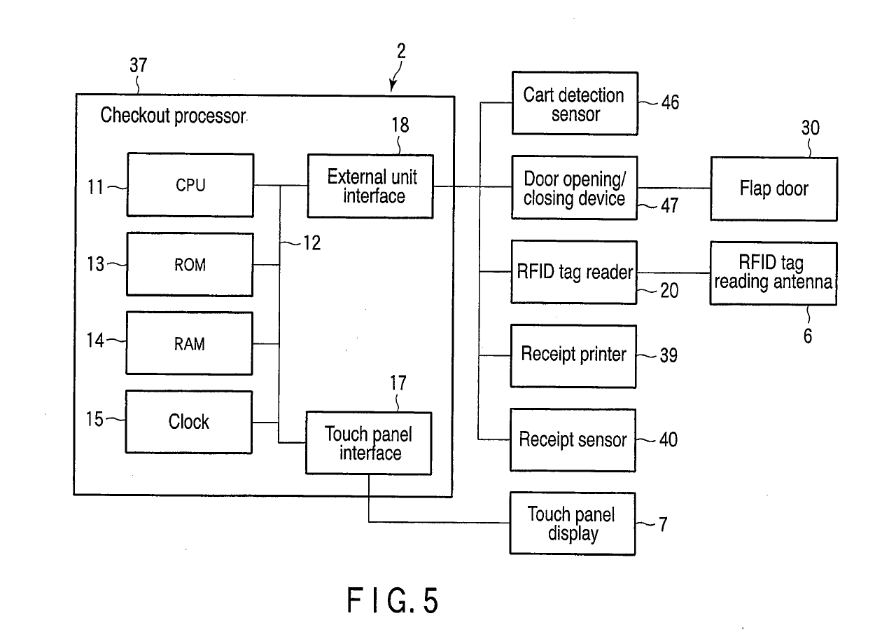

FIG. 5 is a block diagram showing a configuration of essential parts of the RFID tag reading/processing apparatus 2. The RFID tag reading/processing apparatus 2 is provided with the checkout processor 37. The checkout processor 37 is provided with a central processing unit (CPU) 11. The CPU 11 is connected to a read-only memory (ROM) 13, a random-access memory (RAM) 14, a clock 15 to show time and date, a touch panel interface 17, and an external unit interface 18, through a bus line 12 such as an address bus and a data bus.

The touch panel interface 17 controls transmission and reception of data signals to/from the touch panel display 7. The external unit interface 18 controls transmission and reception of data signals to/from a RFID tag reader 20 described later.

The external unit interface 18 is connected to the cart detection sensor 46, the door opening/closing device 47 for opening and closing the flap door 30, the RFID tag reader 20 provided with the RFID tag reading antenna 6, the receipt printer 39, and the receipt detection sensor 40. The touch panel display 7 is connected to the touch panel interface 17.

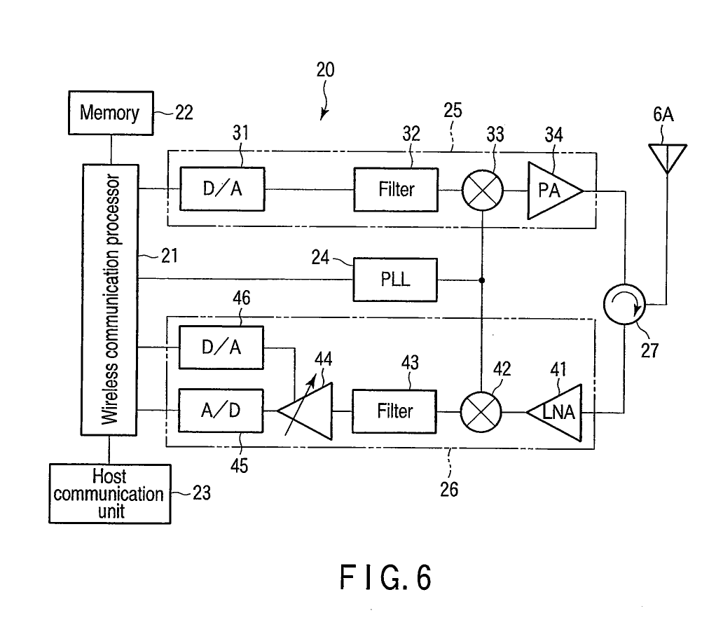

FIG. 6 is a block diagram showing a configuration of essential parts of the RFID tag reader 20.

The RFID tag reader 20 comprises a wireless communication processor 21, a memory 22, a host communication unit 23, a phase locked loop (PLL) 24, a transmitter 25, and a receiver 26. The RFID tag reader 20 is connected to the antenna 6 through a directional coupler 27 such as a circulator.

The wireless communication processor 21 converts transmission data into a digital code by pulse interval encoding (PIE), and sends the encoded transmission data to the transmitter 25. The transmitter 25 converts the input encoded transmission data into an analog signal by a digital-to-analog (DA) converter 31, limits the band of the analog signal by a band-pass filer 32, and supplies the signal to a mixer 33. The mixer 33 receives a local signal with the same frequency as a carrier wave frequency output from the PLL 24. The mixer 33 modulates the analog signal filtered by the band-pass filter 32 using the local signal from the PLL 24.

The transmitter 25 amplifies the modulated transmission signal by the power amplifier 34, sends the amplified signal to the antenna 6 through the directional coupler 27, and emits the signal as a radio wave.

The antenna 6 receives a radio wave transmitted from a RFID tag, and sends a radio signal to the receiver 26 through the directional coupler 27. The receiver 26 amplifies the input radio signal by a low-noise amplifier 41, and supplies the signal to a mixer 42. The mixer 42 demodulates the radio wave signal using local signal output from the PLL 24, and generates a received signal.

The receiver 26 eliminates an unnecessary frequency component from the received signal generated by the mixer 42, through a band-pass filter 43. Then, the receiver amplifiers the received signal by the variable gain amplifier 44, converts the signal into a digital signal by an analog-to-digital (AD) converter 45, and supplies the signal to the wireless communication processor 21.

The wireless communication processor 21 decodes the received signal supplied from the receiver 26 into RFID tag response data, in an RFID tag response signal encoding format, for example, an FMO format. The decoded RFID tag response data is output to the external interface 18 through the host communication unit 23.

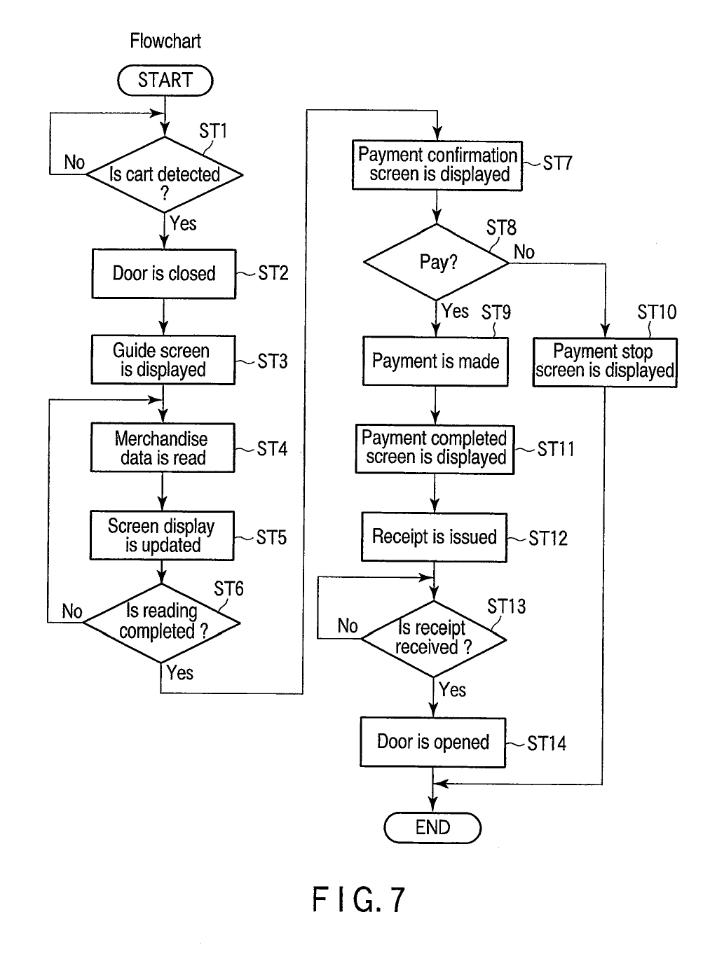

Next, the operation of the above RFID tag reading/processing apparatus will be explained with reference to FIGS. 7 to 12.

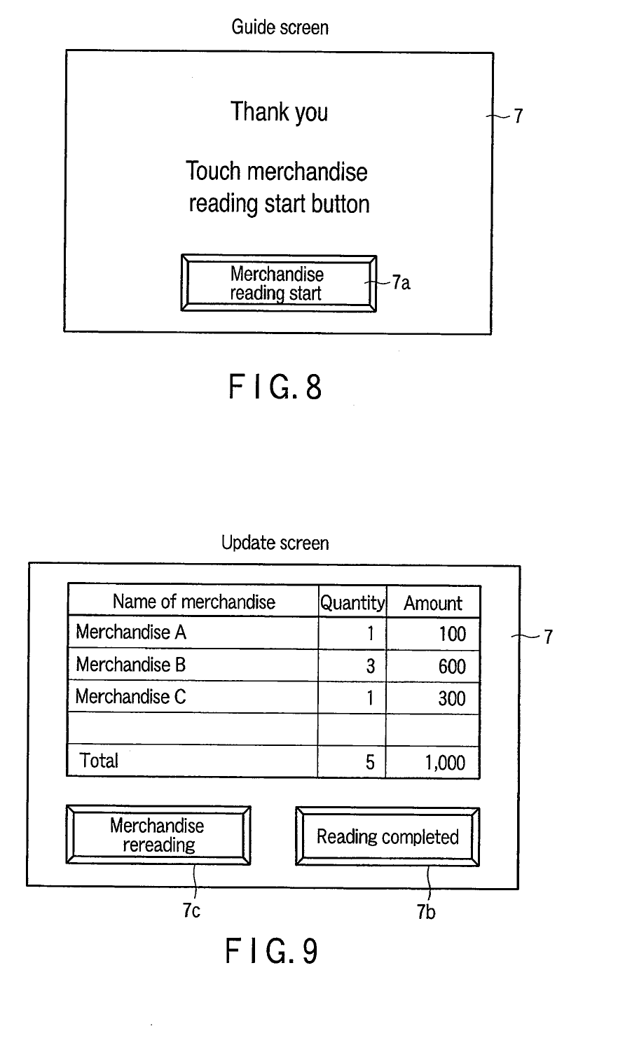

First, the shopping cart 5 with the basket 5a containing merchandise with RFID tags is pushed into the checkout gate 1A (1B or 1C), and detected by the cart detection sensor 46 (step ST1). The detected information is notified to the checkout processor 37. Receiving the notice, the door opening/closing device 47 is operated, and the flap door 30 is closed (step ST2). The touch panel display 7 displays a guide screen shown in FIG. 8 (step ST3). The customer touches a merchandise reading start button 7a on the screen. The RFID tag reader 20 transmits a radio wave from the antenna 6, and starts reading the RFID tag attached to the merchandise (step ST4). The RFID tag reader 20 sends the merchandise information (product ID) read from the RFID tag to the checkout processor 37, until all RFID tags are read. The RFID tag reading operation may be started before the button 7a is touched, before the shopping cart 5 arrives at the flap door 30, or on the way of pushing the cart into the gate. In this case, the customer's waiting time can be short. At the same time, it is possible to prevent omission of RFID tag reading that is positioned at a null-point, because the shopping cart 5 is moved and the merchandise is moved accordingly. Therefore, it is desirable to start reading a RFID tag as soon as the cart detection sensor 46 detects the shopping cart 5.

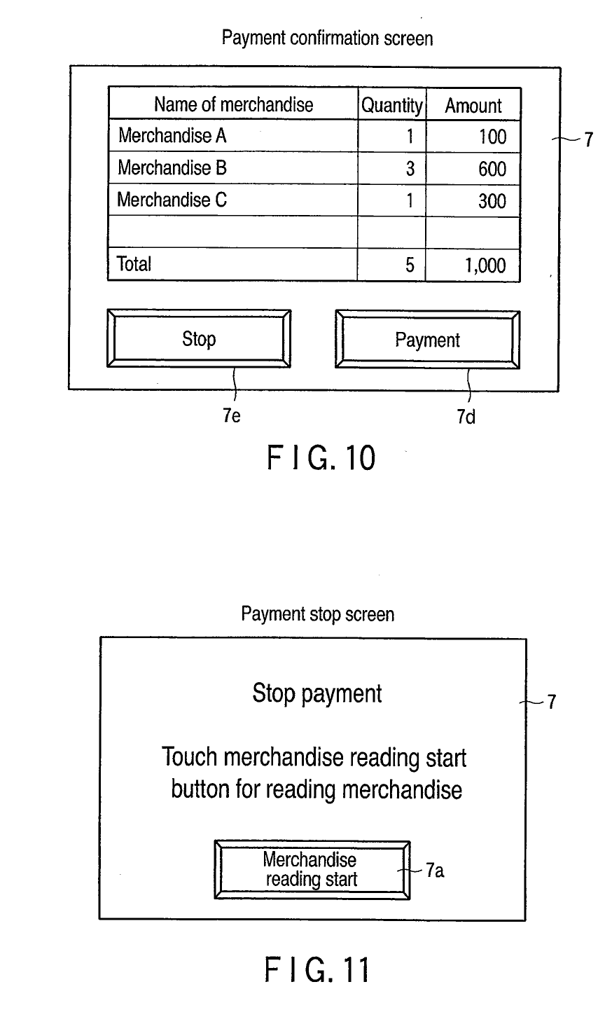

The checkout processor 37 receives merchandise information, and updates the screen display as shown in FIG. 9 (step ST5). The customer touches a reading end button 7b after all wireless tags in the basket 5a of the shopping cart 5 are read, and touches a merchandise rereading button 7c when not all tags are read (step ST6). When the reading completed button 7b is touched, the checkout processor 37 displays a payment confirmation screen shown in FIG. 10 on the touch panel display 7 (step ST7). Reading of RFID tags may be completed when no response is received from a RFID tag during the inventory operation of the RFID tag reader, for example.

The customer determines whether to make payment or not by watching the payment confirmation screen (step ST8), and touches a payment button 7d to make payment, and touches a stop button 7e not to make payment. When the payment button 7d is touched, the payment is made (step ST9). When the stop button 7e is touched, a payment stop screen is displayed on the touch panel display 7 as shown in FIG. 11 (step ST10).

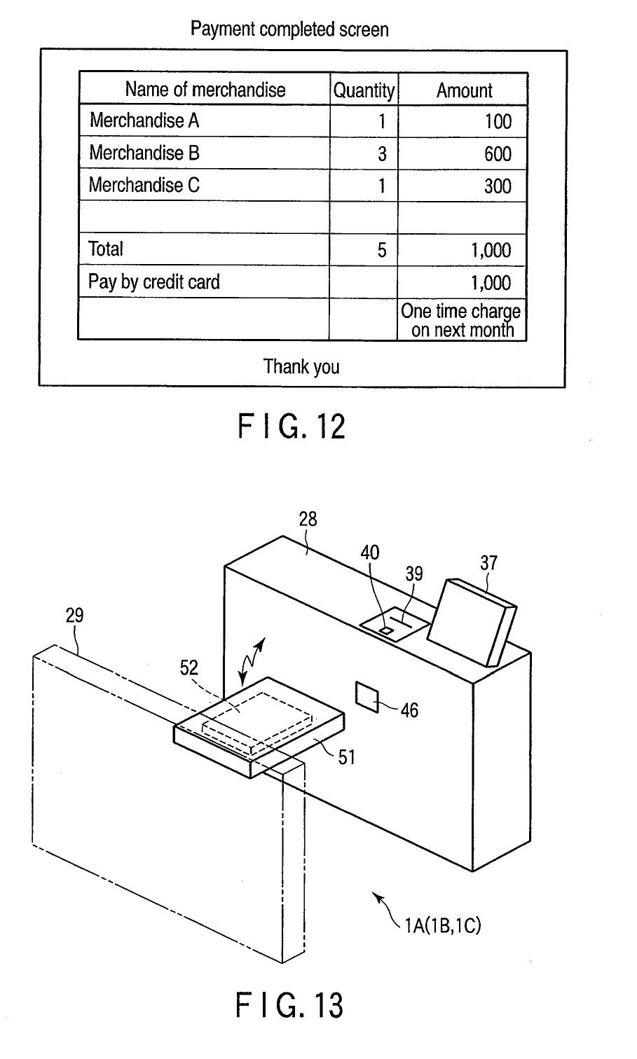

When payment is made, a payment completed screen is displayed as shown in FIG. 12 (step ST11). Then, the receipt printer 39 issues a receipt (step ST12).

After the receipt printer 39 issues the receipt, the receipt detection sensor 40 detects the receipt. The checkout processor 37 judges that the receipt has been received by the customer when the receipt detection sensor 40 does not detect the receipt (step ST13). When the checkout processor 37 judges that the receipt has been received, the flap door 30 is opened, and all payment steps are completed (step ST14).

As described above, according to this embodiment, as the flap door 30 is provided with the antenna 6 of the RFID tag reader 20, and a radio wave is transmitted obliquely upward from the front to rear of the basket 5a of the shopping cart 5, a radio wave transmitted from the antenna 6 is not directed to subsequent shopping carts or shopping carts in adjacent gates.

Therefore, the RFID tags of merchandise in the subsequent shopping carts and shopping carts in adjacent gates are not read, and only the RFID tags of the merchandise contained in an aimed shopping cart can be read. Correct payment is thus possible.

Since the gate need not be covered with a radio wave absorbing material, the gate main unit 28 and the auxiliary board 29 can be made compact.

FIG. 13 shows a RFID tag reading/processing apparatus according to a second embodiment of the invention.

The same parts as those shown in the first embodiment are given the same numbers, and an explanation thereof is omitted.

In the second embodiment, a flap door 51 as an opening/closing door is provided horizontally on the side of a gate main unit 28. An antenna 52 for reading a RFID tag is provided in the flap door 51. The antenna 52 transmits a radio wave upward.

In the second embodiment, when a shopping cart 5 with a basket 5a containing merchandise with RFID tags is pushed into a checkout gate 1A (1B or 1C), and detected by a cart detection sensor 46, the flap door 51 is closed. When the shopping cart 5 pushed further to a predetermined position, the lower side of the basket 5a is positioned above and faced to the flap door 51. In this state, the RFID tag reading antenna 52 transmits a radio wave upward, and reads the RFID tags of the merchandise in the basket.

According to the second embodiment, a radio wave transmitted from the RFID tag reading antenna 52 is not directed to subsequent shopping carts and shopping carts in adjacent gates.

Therefore, the RFID tags of the merchandise in the subsequent shopping carts and shopping carts in adjacent gates are not read, and only the RFID tags of the merchandise contained in an aimed shopping cart can be read. Correct payment is thus possible.

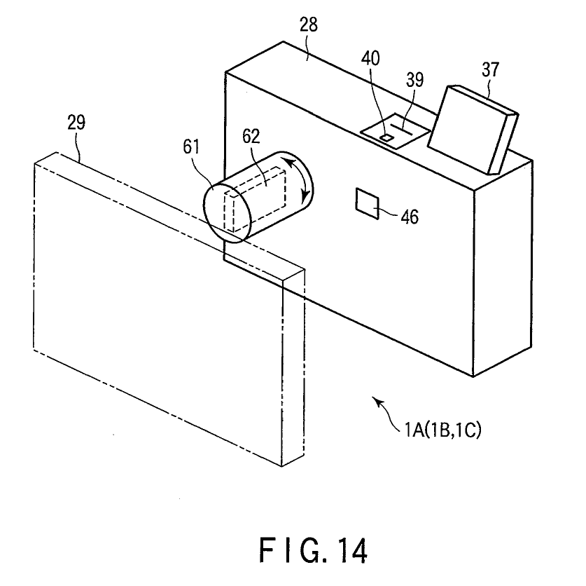

FIG. 14 shows a RFID tag reading/processing apparatus according to a third embodiment of the invention.

The same parts as those shown in the first embodiment are given the same numbers, and an explanation thereof is omitted.

In the third embodiment, a cylindrical gate bar 61 as an opening/closing part is provided on the side of a gate main unit 28. An antenna 62 for reading a RFID tag is provided in the gate bar 61 rotatably in the direction of an arrow. The RFID tag reading antenna 62 rotates, and transmits a radio wave obliquely upward from the front to rear of a basket 5a of a shopping cart 5.

In the third embodiment, when a shopping cart 5 with a basket 5a containing merchandise with RFID tags is pushed into a checkout gate 1A (1B or 1C), and detected by a cart detection sensor 46, the gate bar 61 is closed. When the shopping cart 5 is pushed further to a predetermined position and faced to the gate bar 61, the RFID tag reading antenna 62 transmits a radio wave obliquely upward from the front to rear of the basket 5a of the shopping cart 5, and reads the RFID tags of the merchandise in the basket.

According to the third embodiment, a radio wave transmitted from the RFID tag reading antenna 62 is not directed to subsequent shopping carts and shopping carts in adjacent gates.

Therefore, the RFID tags of the merchandise in the subsequent shopping carts and shopping carts in adjacent gates are not read, and only the RFID tags of merchandise in an aimed shopping cart can be read. Correct payment is thus possible.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An RFID tag reading/processing apparatus comprising:
a gate for passing merchandise with an RFID tag therethrough;
an opening/closing door which is provided with an antenna inside, and opens and closes the gate:
a reading device which reads data of the RFID tag, and transmits a radio wave from the antenna toward the RFID tag, while the opening/closing door is being closed; and
a checkout device which checks out for the merchandise based on the RFID tag data read by the reading device.

2. The RFID tag reading/processing apparatus according to claim 1, wherein the antenna transmits a radio wave obliquely upward from the lower side of the merchandise.

3. The RFID tag reading/processing apparatus according to claim 1, wherein the checkout device comprises an operation unit, and when the merchandise is contained in a moving object having a container, the distance between the operation unit and the closed opening/closing door is longer than the length along the advancing direction of the moving object.

4. The RFID tag reading/processing apparatus according to claim 1, wherein when the checkout by the checkout device is completed, the opening/closing door is opened.

5. The RFID tag reading/processing apparatus according to claim 1, further comprising:
a receipt issuing device for issuing a receipt recording checkout information, when the checkout device completes checkout; and
a receipt detection sensor for detecting whether the receipt issued by the receipt issuing device is received,
wherein when the detection sensor detects that the receipt is received, the opening/closing door is opened.

6. The RFID tag reading/processing apparatus according to claim 1, further comprising:
a moving object detection sensor for detecting a moving object having a container containing the merchandises advanced into the gate,
wherein when the moving object detection sensor detects the moving object, the reading device starts reading data of a RFID tag.

7. The RFID tag reading/processing apparatus according to claim 6, wherein the moving object detection sensor is away from the opening/closing door by a predetermined distance and located upstream of the opening/closing door with respect to a direction in which the moving object is moved, the predetermined distance being approximately ½ of a lengthwise dimension of the moving object as measured in the direction in which the moving object is moved.

8. The RFID tag reading/processing apparatus according to claim 3, wherein when the operation unit of the checkout device is operated, the reading device starts reading data of an RFID tag.

9. An RFID tag reading/processing apparatus comprising:
a gate for passing merchandise with a RFID tag;
an opening/closing door which is provided with an antenna inside, and opens and closes the gate:
a reading device which reads data of the RFID tag, and transmits a radio wave from the antenna from the lower to upper side of the merchandise, while the opening/closing door closed is being closed; and
a checkout device which checks out for the merchandise based on the RFID tag data read by the reading device.

10. The RFID tag reading/processing apparatus according to claim 9, wherein when the merchandise is contained in a container and advanced to the opening/closing door, the opening/closing door is horizontally located under the lower side of the container.

11. An RFID tag reading/processing apparatus comprising:
a gate for passing merchandise with an RFID tag;
an opening/closing part which is provided with a rotatable antenna inside, and opens and closes the gate:
a reading device which reads data of the RFID tag, and transmits a radio wave from the antenna toward the merchandise, while the opening/closing part is being closed; and
a checkout device which checks out for the merchandise based on the RFID tag data read by the reading device.

12. The RFID tag reading/processing apparatus according to claim 11, wherein the opening/closing part is cylindrically shaped.
